(19) United States
(12) Patent Application Publication
(10) Pub. No.: US 2014/0139559 A1
(43) Pub. Date: May 22, 2014

(54) ELECTRONIC DEVICE AND METHOD FOR CONTROLLING TRANSPARENT DISPLAY

(71) Applicant: Samsung Electronics Co., Ltd., Gyeonggi-do (KR)

(72) Inventors: Nagyeom YOO, Gyeonggi-do (KR); Geonsoo KIM, Gyeonggi-do (KR); Hongseok YANG, Gyeonggi-do (KR); Hyungsuk HWANG, Gyeonggi-do (KR)

(73) Assignee: Samsung Electronics Co., Ltd., Gyeonggi-do (KR)

(21) Appl. No.: 14/079,883

(22) Filed: Nov. 14, 2013

(30) Foreign Application Priority Data
Nov. 16, 2012 (KR) 10-2012-0129959

(51) Int. Cl. G09G 5/10

(52) U.S. Cl. CPC G09G 5/10
USPC 345/690

(57) ABSTRACT

An electronic device controls a transparent display using a transparent display unit having a front side, a rear side and a lateral side, and allowing penetration of light. A light transmittance adjustable panel is disposed at one or more sides of the transparent display unit and a control unit automatically adjusts light transmittance of at least part of the transmittance adjustable panel in response to data associated with an event.

### CLAIM OF PRIORITY

This application claims the benefit under 35 U.S.C. §119(a) of a Korean patent application filed on Nov. 16, 2012 in the Korean Intellectual Property Office and assigned Serial No. 10-2012-0129959, the entire disclosure of which is hereby incorporated by reference.

### TECHNICAL FIELD

The present disclosure relates to a transparent display technique and, more particularly, to an electronic device and method for controlling a transparent display by adaptively adjusting transmittance.

### BACKGROUND

Electronic devices are converging to provide many user functions in a single device and some known electronic devices provide a transparent display method. This method renders a display unit transparent allowing the penetration of incident light. Therefore, a user near a device having a transparent display unit may see information displayed on the transparent display unit. This is desirable where the displayed information is sharable with other persons. However, when the preservation of security is required, e.g., when a user enters a password, the exposure of displayed information in known electronic devices is undesirable.

### SUMMARY

A system provides control of a transparent display of an electronic device by selectively blocking penetration of light from or to, all or a part of a transparent display unit when the preservation of security is desired.

An electronic device controls a transparent display using a transparent display unit having a front side, a rear side and a lateral side, and allowing penetration of light. A light transmittance adjustable panel is disposed at one or more sides of the transparent display unit and a control unit automatically adjusts light transmittance of at least part of the transmittance adjustable panel in response to data associated with an event.

In a feature, the device detects occurrence of a specific event and the specific event includes at least one of, an event activating a specific function associated with a predetermined light transmittance adjustment, an event selecting a specific icon or menu item associated with light transmittance adjustment, and an event comprising acquisition of information associated with light transmittance adjustment in predetermined information. The transparent display unit displays at least one of: a light transmittance adjustment icon for light transmittance adjustment for the light transmittance adjustable panel; a light transmittance adjustment release icon for release of the light transmittance adjustment for the light transmittance adjustable panel; a light transmittance setting/release icon to set or release the light transmittance adjustment for the light transmittance adjustable panel; and a partial selection icon to request the light transmittance adjustment for a selected part of the light transmittance adjustable panel, the selected part corresponding to a selected region of the transparent display unit. The control unit automatically adds data identifying a specific function screen to predetermined information associating screens with respective corresponding light transmittance adjustment in response to light transmittance adjustment being requested on the specific function screen.

In another feature, the control unit adjusts the light transmittance of a selected part of the light transmittance adjustable panel when the transparent display unit displays a locked screen or a password input screen, and wherein the selected part corresponds to a selected region of the transparent display unit including a lock pattern display region, a virtual keypad region used to enter a password, an input information display region for showing the entered password, or a related information display region. The control unit adjusts the light transmittance of the light transmittance adjustable panel when a specific touch or gesture predetermined to require light transmittance adjustment for the light transmittance adjustable panel is detected or when a touch-and-drag gesture indicating a specific region through a drawn shape is detected. The control unit changes the light transmittance adjustable panel disposed at the rear side of the transparent display unit from a transparent state to an opaque state and vice versa by adjusting the light transmittance of the light transmittance adjustable panel. A sensor unit captures an image for face recognition and the control unit adjusts the light transmittance of the light transmittance adjustable panel when the captured image is determined to include a human face, and to maintain an unadjusted state when the captured image is determined not to include a human face.

In a further feature, a method controls a transparent display in an electronic device by: activating a sensor unit configured to capture an image for face recognition; analyzing the captured image to determine if the image includes a human face; and in response to the determination, adjusting light transmittance of at least part of a light transmittance adjustable panel disposed on a rear side of a transparent display unit. The adjustment of the light transmittance includes at least one of: adjusting the light transmittance of the light transmittance adjustable panel in response to the determination the captured image includes a human face; and maintaining an unadjusted state in response to the determination the captured image does not include a human face.

### BRIEF DESCRIPTION OF THE DRAWINGS

FIG. 1 shows an exploded view of a transparent display unit and a transmittance adjustable panel of an electronic device according to invention principles.

FIG. 2 shows a block diagram of an electronic device having a transmittance adjusting function according to invention principles.

FIG. 3 shows examples of a transmittance adjustable panel shown in FIG. 2 according to invention principles.

FIG. 4 shows a flow diagram of a method for controlling a transparent display of an electronic device according to invention principles.

FIG. 5 shows a view illustrating a process of adjusting transmittance in response to an input event according to invention principles.

FIG. 6 shows a view illustrating a process of adjusting transmittance in response to a particular user function according to invention principles.

FIG. 7 shows a view illustrating a process of adjusting transmittance for a part of a transparent display according to invention principles.

FIG. 8 shows a view illustrating a process of adjusting transmittance in response to a sensor unit according to invention principles.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

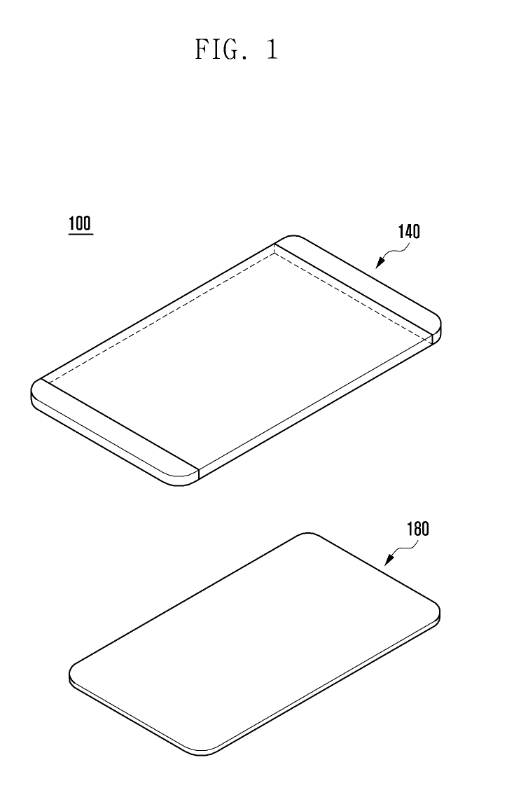

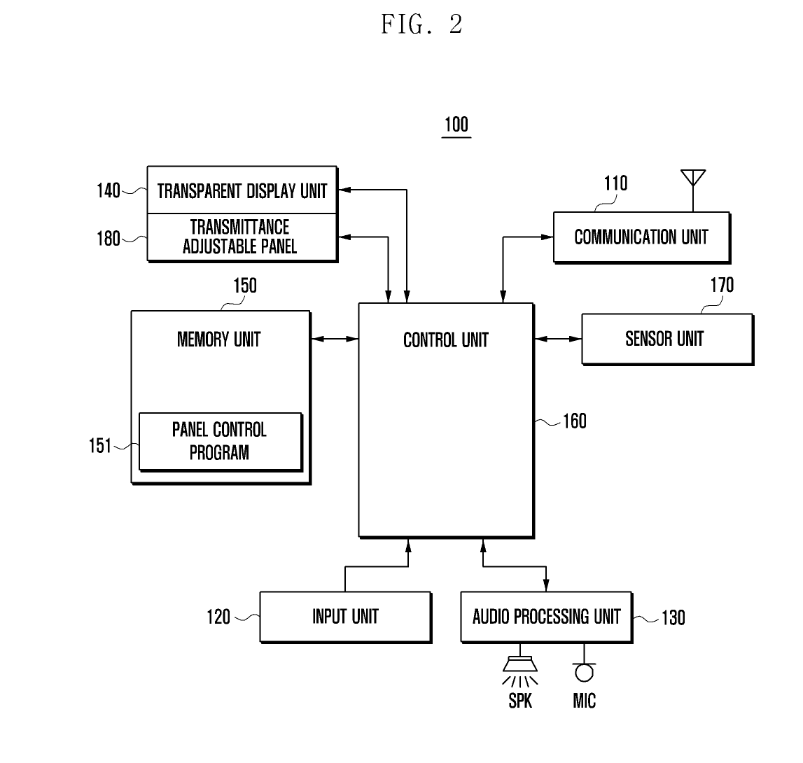

FIG. 1 shows an exploded view of a transparent display unit and a transmittance adjustable panel of an electronic device. FIG. 2 shows an electronic device having a transmittance adjusting function. The electronic device 100 may include a communication unit 110, an input unit 120, an audio processing unit 130, a transparent display unit 140, a memory unit 150, a control unit 160, a sensor unit 170, and a transmittance adjustable panel 180. The device 100 may adjust the transmittance of the transmittance adjustable panel 180 in response to a particular input event or a particular user function so as to block the penetration of light from or to all or part of the transparent display unit 140 in a specific direction. Therefore, the device 100 may prevent the exposure of security information in the use of various user functions.

The communication unit 110 supports a communication function but in another embodiment may be omitted. The communication unit 110 establishes a communication channel with a base station in order to support a communication function. Via such a channel and depending on a user manipulation or predefined schedule, the communication unit 110 may receive information from external entities or transmit information stored in or collected by the device 100 to external entities. The communication unit 110 may use a short-range communication module for forming a short-range communication channel.

Particularly, the communication unit 110 may provide access to a selected server that operates based on a security function and receive a specific page for allowing a user to enter security information, send such security information entered by a user, or receive a new page updated after security information authentication. Additionally, the communication unit 110 may receive security information such as an authentication number from other devices or a server. Security information received by the communication unit 110 or entered by a user may be displayed on the transparent display unit 140. Particularly, when security information is to be entered or displayed during the operation of the communication unit 110, the device 100 may advantageously adjust the transmittance of the transmittance adjustable panel 180 to block the penetration of light from or to all or part of the transparent display unit 140 in a specific direction. For example, when a user desires to purchase a certain item from an item sales server, the communication unit 110 may receive a check-out screen for requiring the input of payment information. In this case, the transmittance adjustable panel 180 may be adjusted to an opaque state to prevent the exposure of payment information.

The input unit 120 creates input signals required for the operation of the device 100. The input unit 120 may employ one or more input methods such as a keyboard, a keypad, key buttons, for example. If the transparent display unit 140 is provided in the form of a touch screen, the input unit 120 may be realized in the form of a virtual touch pad which is displayed on the touch screen.

In response to user manipulation or a predefined schedule, the input unit 120 may create an input signal for activating a specific user function that requires the input or output of security information, and provides the input signal to the control unit 160. Additionally, the input unit 120 may create an input signal corresponding to security information entered in a security information input screen in response to user touch action for example. The input unit 120 may create an input signal for adjusting the transmittance of the transmittance adjustable panel 180. For this, the device 100 may offer some menu items, icons or other graphical elements used for such adjustment.

The audio processing unit 130 may include a speaker (SPK) for outputting audio data defined during the operation of the device 100, audio data associated with playback of audio files stored in the memory unit 150 and audio data received from external entities, for example. Also, the audio processing unit 130 may include a microphone (MIC) for collecting audio data. The audio processing unit 130 may output feedback sounds or sound effects in connection with the operation of the transmittance adjustable panel 180. For example, when the transmittance of the transmittance adjustable panel 180 is adjusted in a situation where security information is to be entered or displayed, the audio processing unit 130 may audibly reproduce the phrase “Transmittance is adjusted for a security issue.” Additionally, the audio processing unit 130 may output specific sound effects when the preservation of security is required and/or when the transmittance of the transmittance adjustable panel 180 is adjusted. Such a function to output feedback sounds and sound effects may be inactivated in response to a user setting.

The transparent display unit 140 may display different screens, such as an idle screen or a menu screen, required for the operation of the device 100. The transparent display unit 140 may show a transparent display region formed of material with particular transmittance. Thus, the transparent display unit 140 may allow the penetration of light from the front to the rear or from the rear to the front. If there is any object at the front or rear of the transparent display unit 140, the incident light from the rear or front may be reflected by the object and be scattered inside or penetrate through the transparent display unit 140. Usually the penetration of light may also occur through lateral sides of the transparent display unit 140. In the transparent display unit 140, elements comprising a display region, including an electrode, a thin film transistor, a pixel electrode, a light emitting diode, for example, may be formed of transparent material. However, the transparent display unit 140 does not have complete transparency due to obstacles to light. Therefore, the transparent display unit 140 fails to have perfect transmittance, so that information displayed on the front can be often observed at the other sides.

The transparent display unit 140 provides screens such as a call screen, a locked screen, an unlocked screen, a web access screen for requiring the input of user authentication information and a check-out screen for requiring the input of payment information, for example. When the transparent display unit 140 displays a screen that requires the preservation of security, e.g., a screen for entering security information or displaying received security information, the parts except the front of the transparent display unit 140 may be blocked by the transmittance adjustable panel 180.

The memory unit 150 may store an operating system and programs required for the operation of the device 100. Further, the memory unit 150 may store data, applications and algorithms for performing user functions. Particularly, the memory unit 150 may store a panel control program 151. The panel control program 151 may selectively adjust the transmittance of the transmittance adjustable panel 180. Specifically, the panel control program 151 may include a checking routine for checking whether the input or output of security information is required during the execution of a user function, and an adjusting routine for adjusting the transmittance of at least part of the transmittance adjustable panel 180 when the input or output of security information is required. The checking routine may include a subroutine for checking whether the input or output of security information occurs, and a subroutine for finding the location of such input or output. The adjusting routine may include a subroutine for adjusting the transmittance of the whole transmittance adjustable panel 180 to an opaque state and a subroutine for adjusting the transmittance of parts of the transmittance adjustable panel 180 to an opaque state.

Additionally, the memory unit 150 may store a face recognition program for identifying neighboring persons through the sensor unit 170, and also store a face recognition database.

The sensor unit 170 may detect surrounding circumstances to be used for adjusting the transmittance of the transmittance adjustable panel 180. The sensor unit 170 may comprise different types of image capture sensor. The sensor unit 170 may analyze collected image signals and, if a predetermined image is detected, may transfer it to the control unit 160. For example, the sensor unit 170 may be activated when the input or output of security information is required, collect surrounding images, and provide them to the control unit 160.

The transmittance adjustable panel 180 may be disposed under the transparent display panel 140 and adjust its transmittance under the control of the control unit 160. The transmittance adjustable panel 180 may include upper and lower glass layers, a liquid crystal layer interposed therebetween, and transparent electrode layers disposed respectively above and under the liquid crystal layer so as to regulate electrically. A known method of electrically adjusting transmittance is described, for example, in U.S. Pat. No. 7,242,027 by J. H. Lee filed 27 Jun. 2001.

The transmittance adjustable panel 180 may be in a transparent state or in an opaque state, depending on the control of electric power supplied under the control of the control unit 160.

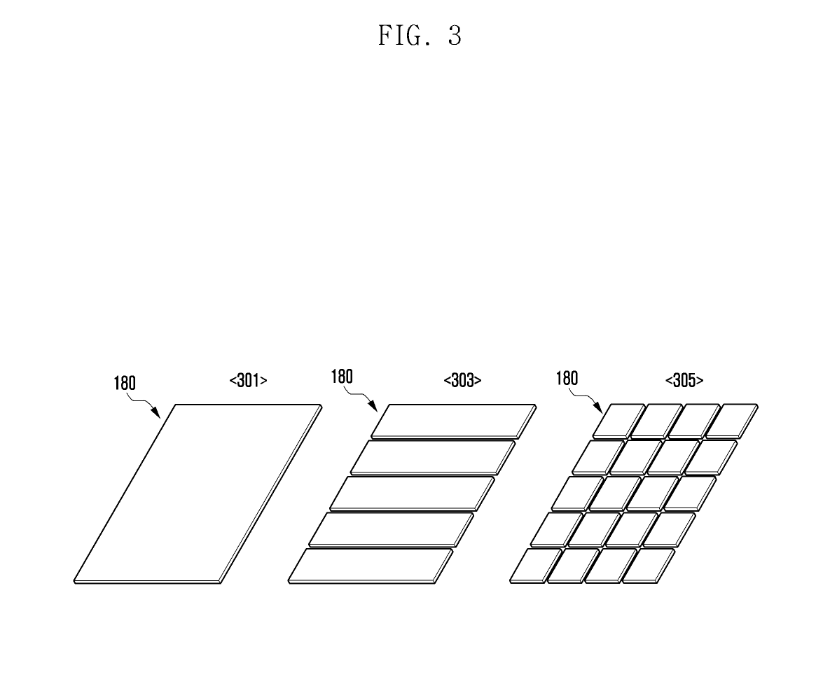

The transmittance adjustable panel 180 may have various forms as shown in FIG. 3. The transmittance adjustable panel 180 may be formed as a single panel 301 and may be transparent or opaque in whole. Alternatively, the transmittance adjustable panel 180 may be divided into two or more stripe-like parts 303 or may be divided into matrix-like parts 305. The transmittance adjustable panel 180 divided into stripe-like or matrix-like parts may be transparent or opaque in part under the control of the control unit 160. Therefore, the transmittance adjustable panel 180 may render all or part of the transparent display unit 140 opaque. Although the transmittance adjustable panel 180 is depicted as being disposed at the rear of the transparent display unit 140, this is exemplary only. Alternatively, the transmittance adjustable panel 180 may encompass lateral sides of the transparent display unit 140 and thus selectively render such lateral sides opaque.

The control unit 160 may process and transfer a variety of control signals and data in connection with the operation of the device 100. Particularly, the control unit 160 may control the transmittance adjustable panel 180 to prevent the exposure of security information.

Specifically, the control unit 160 may check whether the device 100 is in a specific environment that requires the input or output of security information. The control unit 160 may output a security information input screen that requires the input of security information, and detect the input of security information. The control unit 160 may detect the reception of security information from an external entity before the output of security information. As a result, the control unit 160 may recognize in advance the occurrence of an event that requires the input or output of security information.

When the security information input screen is output to the transparent display unit 140, the control unit 160 may control the transmittance adjustable panel 180 to be in an opaque state. Alternatively, the control unit 160 may control selected parts of the transmittance adjustable panel 180 to be in an opaque state while keeping the other parts in a transparent state. Selected parts may be, for example, a password input part on a locked screen, a virtual keypad part for entering security information, or any part for displaying security information. For controlling selected parts, the transmittance adjustable panel 180 may be formed of stripe-like or matrix-like parts as discussed above. Further, the control unit 160 may output feedback sounds, sound effects, messages or graphical representations through the audio processing unit 130 or the transparent display unit 140 in order to inform a user of potential security risk by display of security information.

Additionally, in response to a message of a specific type being received from another device or web server, the control unit 160 may adjust the transmittance of the transmittance adjustable panel 180 such that other persons cannot see the received message. In some cases, the control unit 160 may maintain an unadjusted state of the transmittance adjustable panel 180 and inform a user about the reception of a message, and adjusts the transmittance adjustable panel 180 to be in an opaque state in response to occurrence of an input event and opening of the received message. The message may include security information, a text or multimedia message, a chat message or an email, for example.

The control unit 160 may automatically adjust the transmittance of the transmittance adjustable panel 180 when a particular user function specified by a user is performed. The control unit 160 may provide a setting screen that allows a user to select at least one user function that requires variations in the transmittance of the transmittance adjustable panel 180. Further, the control unit 160 may output a menu item or icon for displaying the setting screen on the transparent display unit 140. Therefore, a user can select at least one user function on the setting screen such that the transmittance adjustable panel 180 is automatically changed from a transparent state to an opaque state and vice versa in response to the activation of an associated selected user function. Alternatively or additionally, the control unit 160 may provide the transparent display unit 150 with a menu item for adjusting the transmittance of the transmittance adjustable panel 180 while a user function is performed. Therefore, a user can select this menu item during the execution of a function such that the transmittance adjustable panel 180 is substantially immediately changed from a transparent state to an opaque state and vice versa in response to user selection.

Also, the control unit 160 may control the sensor unit 170 and, depending on whether there is a person near the rear of the device 100, adjust the transmittance of the transmittance adjustable panel 180. Specifically, the control unit 160 may activate the image capture sensor and then perform face recognition in a preview image to determine whether there is a person near the rear of the device 100. If any person exists, the control unit 160 may adjust the transmittance of the transmittance adjustable panel 180 to be in an opaque state. If no person exists, the control unit 160 may maintain an unadjusted state. In response to results of face recognition through the sensor unit 170, the control unit 160 may selectively adjust the transmittance of the transmittance adjustable panel 180. This function may be selectively provided when the preservation of security is required.

Besides, the control unit 160 may output, to the transparent display unit 140, a virtual button key for optionally adjusting the transmittance of the transmittance adjustable panel 180, and/or allocate such a function to a specific key of the input unit 120. When the above virtual button key or specific key is selected, the control unit 160 may recognize it as an input signal for adjusting the transmittance of the transmittance adjustable panel 180 and control a required adjustment. A user can optionally adjust the transparency of the transparent display unit 140 when the preservation of security is needed, using the virtual button key or specific key.

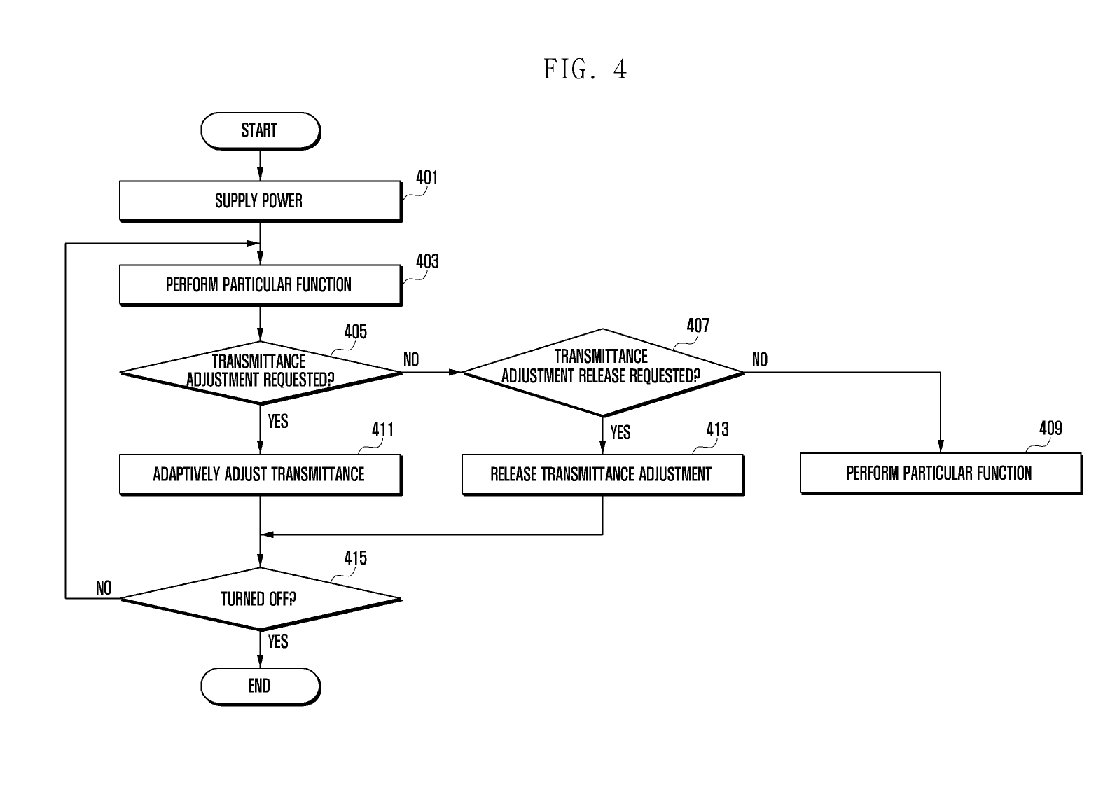

FIG. 4 shows a flow diagram of a method for controlling a transparent display of an electronic device. At operation 401, the control unit 160 supplies electric power to respective elements of the device 100. At operation 403, the control unit 160 performs a particular function in response to user input or a predetermined schedule. For example, at operation 403, the control unit 160 performs a function to display a locked screen, a function to request a user to enter security information such as password, a function to display security information entered by a user or received from other device or a function to access a web server, for example.

While a particular function is performed, the control unit 160 determines at operation 405 whether there is a request for adjusting transmittance. This request event includes at least one of, an event of selecting a specific icon or menu item to receive a request for transmittance adjustment, an event of triggering the activation of a specific user function predefined to require transmittance adjustment, and an event where information predefined to require transmittance adjustment is entered, received or displayed. If there is no event for requesting transmittance adjustment, the control unit 160 determines at operation 407 whether there is a request for releasing transmittance adjustment. This release request event includes an event selecting a specific icon or menu item to receive a request for releasing transmittance adjustment, an event where a specific user function requiring transmittance adjustment is inactivated, and an event where the input or output of information requiring transmittance adjustment is terminated. If there is no event for requesting a release of transmittance adjustment, the control unit 160 performs a particular function at operation 409 without adjusting transmittance or activating a new user function in response to a related input event.

If an event for requesting transmittance adjustment occurs at operation 405, the control unit 160 adjusts the transmittance of the transmittance adjustable panel 180 at operation 411. In response to type of the transmittance adjustable panel 180 as shown in FIG. 3, the control unit 160 adjusts the transmittance of the transmittance adjustable panel 180 in whole or at least in part. Particularly, the control unit 160 adjusts the transmittance of a selected part of the transmittance adjustable panel 180. The selected part corresponds to a specific region of the transparent display unit 140 on which security-related information is displayed. If an event for requesting a release of transmittance adjustment occurs at operation 407, the control unit 160 releases a transmittance adjustment function of the transmittance adjustable panel 180 at operation 413.

Thereafter, at operation 415, the control unit 160 determines whether an input signal for turning off the device 100 is received. If there is no turn-off event, the control unit 160 returns to operation 403 and repeats the process from operation 403 if a turn-off event occurs, the control unit 160 turns off the device 100.

At operation 405, the control unit 160 activates the sensor unit 170 and check whether there is a person near the rear of the device 100. For this, the control unit 160 activates an image capture sensor capturing a preview image in the rear-facing direction of the device 100, and performs face recognition within a preview image to determine whether there is a person at the rear of the device 100. If a person is present, the control unit 160 adjusts the transmittance of the transmittance adjustable panel 180 at operation 411. If no person is present, the control unit 160 does not perform transmittance adjustment even though there is a request for adjusting transmittance. After the transmittance adjustable panel 180 is adjusted to an opaque state, the control unit 160 further performs transmittance adjustment at regular intervals or in real time, depending on whether there is a person near the rear of the device 100.

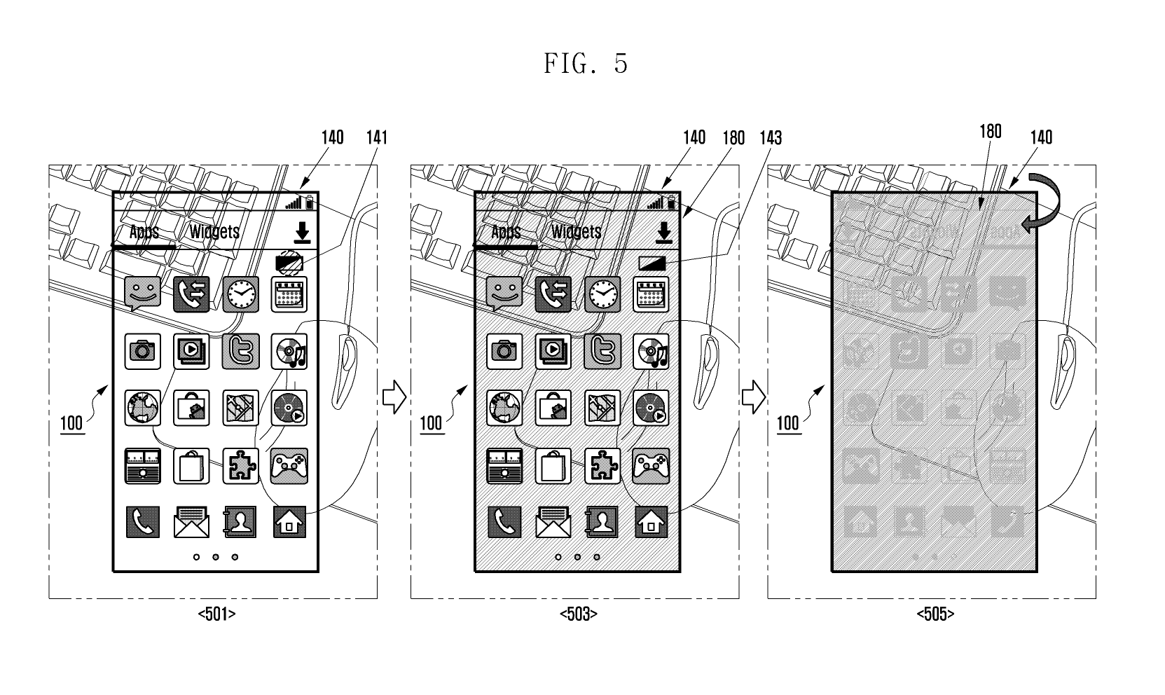

FIG. 5 shows a process of adjusting transmittance in response to an input event. At stage 501, the device 100 having the transparent display unit 140 may allow incident light to pass from the front to the rear and vice versa, so that information displayed on the transparent display unit 140 may be exposed in several directions. At stage 501, the transparent display unit 140 displays various icons and/or widgets. If an input event for requesting transmittance adjustment occurs at stage 501, the transparent display unit 140 may be rendered opaque as shown at stage 503. A user can create such an input event. For example, a user can take a predetermined touch gesture or another predetermined action gesture such as shaking or tilting based on an acceleration sensor for example. Also, as another input event, a user can touch a transmittance adjustment icon 141 to request transmittance adjustment.

When the transmittance adjustment icon 141 is selected or data representing a corresponding touch gesture or action gesture received, the control unit 160 may change the state of the transmittance adjustable panel 180 from a transparent state to an opaque state as shown at stage 501. Control unit 160 may further change the transmittance adjustment icon 141 to a transmittance adjustment release icon 143 on the transparent display unit 140. If data representing the transmittance adjustment release icon 143 is selected or a corresponding touch gesture or action gesture is received, the control unit 160 may return to stage 501.

Stage 503 shows the front of the device 100, and stage 505 shows the rear of the device 100. As shown at stage 505, since the transmittance adjustable panel 180 disposed at the rear of the transparent display unit 140 is in an opaque state, any information displayed on the transparent display unit 140 may not be exposed to the rear of the device 100.

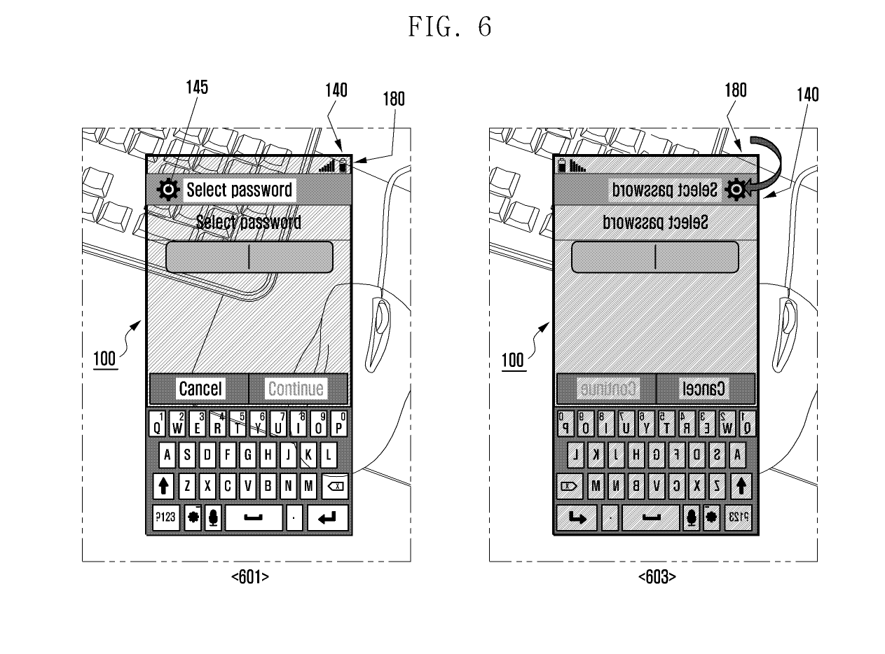

FIG. 6 shows a process of adjusting transmittance in response to a particular user function. If a security-related function such as a password input function is activated, the device 100 may block the exposure of information toward the rear of the transparent display unit 140 as shown at stages 601 and 603 by adjusting the transmittance of the transmittance adjustable panel 180 to an opaque state. Shown at stage 601 is the front of the device 100, and shown at stage 603 is the rear of the device 100. As shown at stage 603, the transmittance adjustable panel 180 may have a dim state, i.e., a less opaque state, such that information displayed on the transparent display unit 140 can be partially seen from the rear. Such adjustment of transmittance may depend on a default or user setting. Additionally or alternatively, the transmittance adjustable panel 180 may have a complete opaque state so as to fully block an exposure toward the rear.

As shown at stages 601 and 603, the control unit 160 of the device 100 may adjust the transmittance of the transmittance adjustable panel 180 while a specific user function that requires the preservation of security is performed, e.g., when a password input is required. Similarly, while a locked screen is displayed on the transparent display unit 140, the control unit 160 may adjust the transmittance of the transmittance adjustable panel 180. Additionally, a user can adjust the transmittance of the transmittance adjustable panel 180 where preservation of security is needed while a specific user function is performed. For this, the transparent display unit 140 may display a transmittance setting/release icon 145 used for setting or releasing the transmittance adjustment of the transmittance adjustable panel 180. If this icon 145 is selected on a certain function screen, the control unit 160 may adjust the transmittance of the transmittance adjustable panel 180 and also add this function screen to a transmittance adjustment list. If the same function screen is called in the future, the control unit 160 may check the transmittance adjustment list and automatically adjust the transmittance of the transmittance adjustable panel 180. The transmittance adjustment list may contain an automatically registered function screen such as a password input screen or a locked screen, and a specific function screen newly added through the transmittance setting/release icon 145. If an input signal for releasing transmittance adjustment is received while a function screen is activated, the control unit 160 may remove the function screen from the transmittance adjustment list.

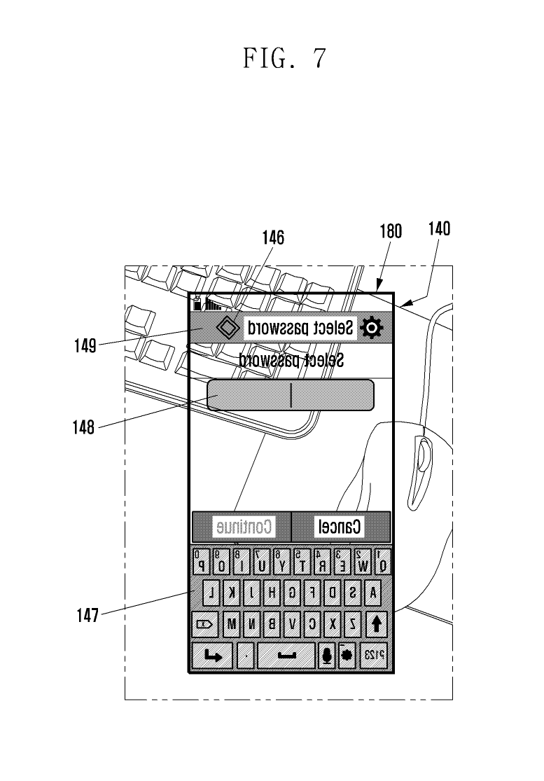

FIG. 7 shows a process of adjusting transmittance for a part of a transparent display. When a request for transmittance adjustment is received, the control unit 160 may adjust the transmittance of a part of the transmittance adjustable panel 180. As previously described in FIG. 3, the transmittance adjustable panel 180 may be formed of a stripe-like or matrix-like type that allows, in part, transmittance adjustment. The control unit 160 may detect at least one region that requires blocking the exposure of information on the transparent display unit 140, such as a virtual keypad region 147 used to enter security information, and an input information display region 148 for showing entered security information. In response to the detection, the control unit 160 may selectively adjust the transmittance of the transmittance adjustable panel 180. Parts of the transmittance adjustable panel 180 corresponding to the virtual key pad region 147 and the input information display region 148 may be adjusted to be in an opaque state. Security information entered through the virtual keypad region 147 may be confidentially represented as special characters. In such case, a part of the transmittance adjustable panel 180 corresponding to the input information display region 148 may not be adjusted.

The control unit 160 may adjust a part of the transmittance adjustable panel 180 corresponding to a related information display region 149 to be in an opaque state. The related information display region 149 may show information about type, title, address, for example of a function screen currently displayed on the transparent display unit 140. Also, the control unit 160 may change the state of a part of the transmittance adjustable panel 180 corresponding to a specific region of the transparent display unit 140 selected by user input. Specifically, the device 100 may output a partial selection icon 146 to the transparent display unit 140. The partial selection icon 146 may be used for selectively adjusting the transmittance of the transmittance adjustable panel 180. A user touches the partial selection icon 146 and creates an input event to select a particular region on the transparent display unit 140. In response to this input event, the control unit 160 may adjust the transmittance of a part of the transmittance adjustable panel 180 corresponding to the appointed region of the transparent display unit 140. For example, on the transparent display unit 140 that displays a specific function screen, a user can create a touch event or gesture event that indicates at least part of a specific image or text, or a touch gesture drawing an enclosed shape defining a desired region such as a circle or a square, for example. When the transmittance adjustable panel 180 is kept in an opaque state, the control unit 160 may change the opaque state to a transparent state for at least part of the transmittance adjustable panel 180 in response to a user input event or a state change history.

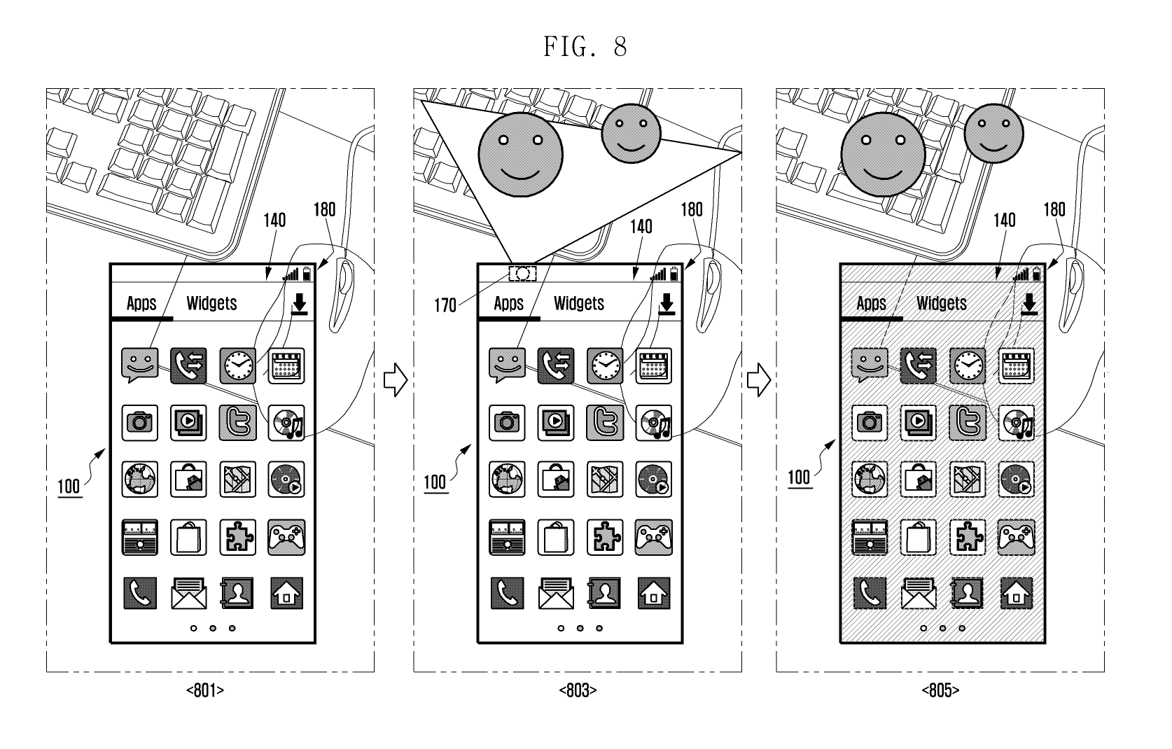

FIG. 8 shows a process of adjusting transmittance in response to a sensor unit. At stage 801, the control unit 160 of the device 100 may keep the transmittance adjustable panel 180 in a transparent state. The transparent display unit 140 may display a specific function screen in response to a user input or a predefined schedule. A plurality of icons and/or widgets may be displayed on the transparent display unit 140, and a specific function screen may be replaced by a locked screen or a password input screen, for example. While a specific function screen is displayed on the transparent display unit 140, the control unit 160 may check at stage 803, using the sensor unit 170, whether there is any subject such as a human face toward the rear of the transparent display unit 140. If there is a person, the control unit 160 may adjust the transmittance of the transmittance adjustable panel 180 to an opaque state as shown at stage 805.

Additionally, the control unit 160 may check at regular intervals or in real time whether there is a person near the rear of the transparent display unit 140. For this, the sensor unit 170 is disposed at the rear of the device 100. The control unit 160 may perform face recognition in a preview image captured by the sensor unit 170. If a subject recognized as the same face is maintained for a given time, the control unit 160 may consider it as a valid result of face recognition and adjust the transmittance of the transmittance adjustable panel 180. Alternatively, as soon as a subject is recognized as a human face, the control unit 160 may adjust the transmittance of the transmittance adjustable panel 180.

The control unit 160 may activate the sensor unit 170, depending on the type of a function screen displayed on the transparent display unit 140 or when a related user input event occurs. For example, the control unit 160 may activate the sensor unit 170 and perform face recognition when a specific screen, e.g., a locked screen, which requires the input or output of security information such as password is displayed on the transparent display unit 140. Alternatively, the control unit 160 may activate the sensor unit 170 when a specific input event, e.g., for releasing a lock state, initially occurs on a screen. Thus, by regulating the time to activate the sensor unit 170, the control unit 160 improves charge battery life.

Device 100 may include other elements such as a short-range communication module, a wired or wireless communication interface, an Internet communication module and a digital broadcast receiving module, for example. Additionally, the device 100 may be applied to various types of mobile communication terminals such as a cellular phone, a smart phone, a tablet PC, a handheld PC, a PMP (portable multimedia player), a PDA (personal digital assistant), a notebook and a portable game console, for example.

While this disclosure has been particularly shown and described with reference to an exemplary embodiment thereof, it will be understood by those skilled in the art that various changes in form and details may be made therein without departing from the spirit and scope of this disclosure as defined by the appended claims.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.”

What is claimed is:

1. An electronic device for controlling a transparent display, the device comprising:
a transparent display unit having a front side, a rear side and a lateral side, and allowing penetration of light;
a light transmittance adjustable panel disposed at one or more sides of the transparent display unit; and
a control unit configured to automatically adjust light transmittance of at least part of the transmittance adjustable panel in response to data associated with an event.

2. The device of claim 1, wherein the control unit is further configured to detect occurrence of a specific event and the specific event includes at least one of,
an event activating a specific function associated with a predetermined light transmittance adjustment,
an event selecting a specific icon or menu item associated with light transmittance adjustment, and
an event comprising acquisition of information associated with light transmittance adjustment in predetermined information.

3. The device of claim 2, wherein the transparent display unit is configured to display at least one of:
a light transmittance adjustment icon for light transmittance adjustment for the light transmittance adjustable panel;
a light transmittance adjustment release icon for release of the light transmittance adjustment for the light transmittance adjustable panel;
a light transmittance setting/release icon to set or release the light transmittance adjustment for the light transmittance adjustable panel; and
a partial selection icon to request the light transmittance adjustment for a selected part of the light transmittance adjustable panel, the selected part corresponding to a selected region of the transparent display unit.

4. The device of claim 2, wherein the control unit is configured to automatically add data identifying a specific function screen to predetermined information associating screens with respective corresponding light transmittance adjustment in response to light transmittance adjustment being requested on the specific function screen.

5. The device of claim 1, wherein the control unit is configured to adjust the light transmittance of a selected part of the light transmittance adjustable panel when the transparent display unit displays a locked screen or a password input screen, and wherein the selected part corresponds to a selected region of the transparent display unit including a lock pattern display region, a virtual keypad region used to enter a password, an input information display region for showing the entered password, or a related information display region.

6. The device of claim 1, wherein the control unit is further configured to adjust the light transmittance of the light transmittance adjustable panel when a specific touch or gesture predetermined to require light transmittance adjustment for the light transmittance adjustable panel is detected or when a touch-and-drag gesture indicating a specific region through a drawn shape is detected.

7. The device of claim 1, wherein the control unit is further configured to change the light transmittance adjustable panel disposed at the rear side of the transparent display unit from a transparent state to an opaque state and vice versa by adjusting the light transmittance of the light transmittance adjustable panel.

8. The device of claim 1, further comprising:
a sensor unit configured to capture an image for face recognition,
wherein the control unit is further configured to adjust the light transmittance of the light transmittance adjustable panel when the captured image is determined to include a human face, and to maintain an unadjusted state when the captured image is determined not to include a human face.

9. A method for controlling a transparent display in an electronic device, the method comprising:
displaying a specific function screen, associated with operation of the device, on a transparent display unit having a front side, a rear side and a lateral side and allowing penetration of light;
receiving a request for adjusting light transmittance of at least part of a light transmittance adjustable panel disposed at one or more sides of the transparent display unit; and
in response to the received request, adjusting the light transmittance of at least part of the light transmittance adjustable panel.

10. The method of claim 9, wherein the receiving of the request includes at least one of:
detecting occurrence of an event of activating a specific function associated with a predetermined light transmittance adjustment;
receiving an event of selecting a specific icon or menu associated with light transmittance adjustment; and
acquiring information associated with light transmittance adjustment in predetermined information.

11. The method of claim 10, comprising:
displaying, on the specific function screen, a light transmittance adjustment icon for initiating light transmittance adjustment of the light transmittance adjustable panel.

12. The method of claim 11, comprising:
automatically adding data identifying the specific function screen to predetermined information associating screens with respective corresponding light transmittance adjustment in response to light transmittance adjustment being requested on the specific function screen.

13. The method of claim 9, wherein the receiving of the request comprises identifying that a locked screen or a password input screen is displayed on the transparent display unit.

14. The method of claim 13, wherein the adjusting of the light transmittance includes adjusting the light transmittance of a selected part of the light transmittance adjustable panel, the selected part corresponding to a selected region of the transparent display unit including a lock pattern display region, a virtual keypad region used to enter a password, an input information display region for showing the entered password, or a related information display region.

15. The method of claim 9, wherein the receiving of the request includes at least one of:
receiving data identifying a specific touch gesture predetermined to require light transmittance adjustment for the light transmittance adjustable panel;
receiving data identifying a specific action gesture predetermined to require light transmittance adjustment for the light transmittance adjustable panel; and
receiving data identifying a touch-and-drag event indicating a specific region through a drawn shape.

16. The method of claim 9, wherein the adjusting of the light transmittance includes at least one of:
changing the light transmittance adjustable panel disposed at the rear side of the transparent display unit from a transparent state to an opaque state; and
changing the light transmittance adjustable panel disposed at the rear side of the transparent display unit from an opaque state to a transparent state.

17. The method of claim 9, wherein the receiving of the request includes:
activating a sensor unit configured to capture an image for face recognition; and
determining whether the image captured by the sensor unit includes a human face.

18. The method of claim 17, wherein the adjusting of the light transmittance includes at least one of:
adjusting the light transmittance of the light transmittance adjustable panel in response to the captured image including a human face; and
maintaining an unadjusted state when the captured image fails to contain a subject recognized as a human face.

19. A method for controlling a transparent display in an electronic device, the method comprising:
activating a sensor unit configured to capture an image for face recognition;
analyzing the captured image to determine if the image includes a human face; and
in response to the determination, adjusting light transmittance of at least part of a light transmittance adjustable panel disposed on a rear side of a transparent display unit.

20. The method of claim 19, wherein the adjusting of the light transmittance includes at least one of:
adjusting the light transmittance of the light transmittance adjustable panel in response to the determination the captured image includes a human face; and
maintaining an unadjusted state in response to the determination the captured image does not include a human face.
